(19) United States
(12) Patent Application Publication
(10) Pub. No.: US 2012/0168197 A1
(43) Pub. Date: Jul. 5, 2012

(54) COAXIAL CABLE STRUCTURE WITH EXTRUDED SHIELDING LAYER

(75) Inventor: Ching-Yang Chiu, Taipei (TW)

(73) Assignee: PRIMECON TECHNOLOGY LTD., Taipei (TW)

(21) Appl. No.: 12/984,392

(22) Filed: Jan. 4, 2011

(51) Int. Cl. H01B 7/17

(52) U.S. Cl. 174/107

(57) ABSTRACT

A coaxial cable structure includes a central conductor, an insulating layer surrounding the central conductor, a shielding layer surrounding the insulating layer and being formed by mixing and extruding at least a first conductive material and a second conductive material, and an outer jacket surrounding the shielding layer. The coaxial cable structure uses the extruded shielding layer surrounding the insulating layer to replace the woven shielding layer used in prior art coaxial cables, so as to provide enhanced shielding effect while allowing the coaxial cable to be manufactured with reduced material in upgraded efficiency.

### FIELD OF THE INVENTION

The present invention relates to a coaxial cable structure, and more particularly to a coaxial cable structure that uses an extruded shielding layer surrounding an insulating layer to replace the conventional woven shielding layer in order to provide enhanced shielding effect while allowing the coaxial cable to be manufactured with reduced material in upgraded efficiency.

### BACKGROUND OF THE INVENTION

Generally, a conventional coaxial cable 2 as shown in FIGS. 1 and 2 includes a central conductor 21, an insulating layer 22 surrounding the central conductor 21, a woven shielding layer 23 surrounding the insulating layer 22, and an outer jacket 24 surrounding the woven shielding layer 23. The coaxial cable 2 is used with connectors (not shown) for transmitting signals between electronic apparatus.

The conventional coaxial cable 2 uses the woven shielding layer 23 to prevent interference by noise. However, the woven shielding layer 23 is formed by interlacing and weaving a plurality of very thin wires into a multi-layer structure. Due to the woven shielding layer 23, the conventional coaxial cable 2 is disadvantageously manufactured with increased material in low efficiency. Moreover, since there are voids formed on the woven shielding layer 23, the coaxial cable 2 in practical use tends to have relatively poor shielding effect.

It is therefore desirable to develop a coaxial cable structure that replaces the conventional woven shielding layer with an improved shielding layer without voids or clearances, so that the coaxial cable can be manufactured with reduced material in upgraded efficiency and provide better shielding effect.

### SUMMARY OF THE INVENTION

A primary object of the present invention is to provide a coaxial cable structure that uses an extruded shielding layer surrounding an insulating layer to replace the conventional woven shielding layer in order to provide enhanced shielding effect while allowing the coaxial cable to be manufactured with reduced material in upgraded efficiency.

To achieve the above and other objects, the coaxial cable structure according to the present invention includes a central conductor; an insulating layer surrounding the central conductor; a shielding layer surrounding the insulating layer and being formed by mixing and extruding at least a first conductive material and a second conductive material; and an outer jacket surrounding the shielding layer.

In an embodiment of the present invention, the central conductor is made of a copper material.

In an embodiment of the present invention, the insulating layer can be made of plastics, rubber, polytetrafluoroethylene (PTFE), polyvinylchloride (PVC), or other equivalent materials with similar property.

In an embodiment of the present invention, the first conductive material can be conductive plastics or other metal materials with similar property.

In an embodiment of the present invention, the second conductive material can be metal powder or other metal materials with similar property.

In an embodiment of the present invention, the outer jacket can be made of plastics, rubber, PTFE, PVC, or other equivalent materials with similar property.

With the above arrangements, the coaxial cable structure of the present invention, which uses an extruded shielding layer surrounding an insulating layer to replace the conventional woven shielding layer, can provide enhanced shielding effect while allowing the coaxial cable to be manufactured with reduced material in upgraded efficiency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a plan view showing a conventional coaxial cable;

FIG. 2 is a cross-sectional view of the conventional coaxial cable of FIG. 1;

FIG. 3 is a plan view showing a coaxial cable structure according to a first embodiment of the present invention; and

FIG. 4 is a cross-sectional view of the coaxial cable structure according to the first embodiment of the present invention.

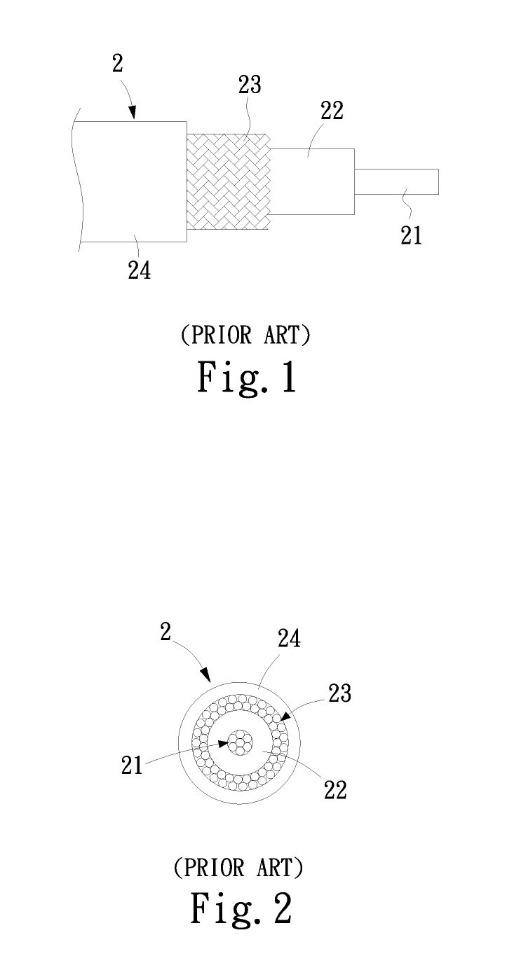

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

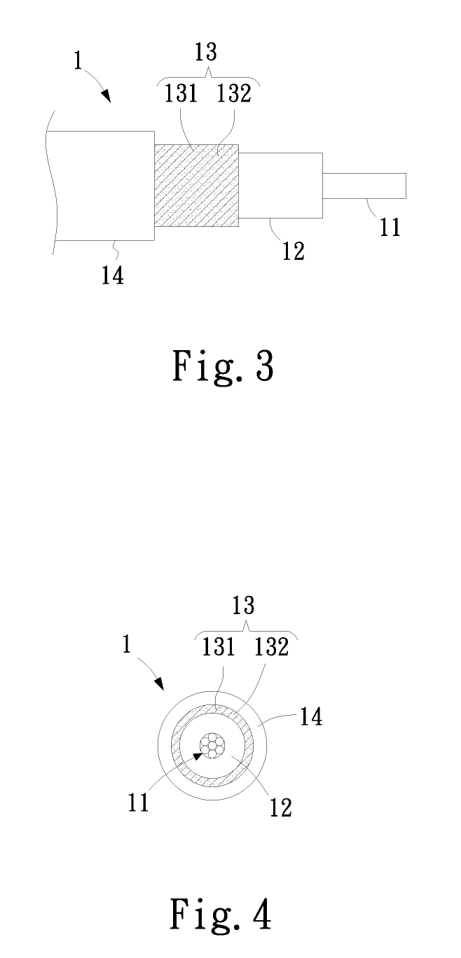

Please refer to FIGS. 3 and 4 that are plan and cross-sectional views, respectively, of a coaxial cable structure 1 according to a first embodiment of the present invention. As shown, the coaxial cable structure 1 in the first embodiment of the present invention includes a central conductor 11, an insulating layer 12, a shielding layer 13, and an outer jacket 14.

The central conductor 11 can be made of a copper material.

The insulating layer 12 surrounds the central conductor 11 and can be made of plastics, rubber, polytetrafluoroethylene (PTFE), polyvinylchloride (PVC), or other equivalent materials with similar property.

The shielding layer 13 surrounds the insulating layer 12, and is formed by mixing and extruding at least a first conductive material 131 and a second conductive material 132. The first conductive material 131 can be conductive plastics or other materials with similar property; and the second conductive material can be metal powder or other materials with similar property.

The outer jacket 14 surrounds the shielding layer 13 and can be made of plastics, rubber, PTFE, PVC, or other equivalent materials with similar property.

To manufacturing the coaxial cable structure 1 according to the present invention, first form the insulating layer 12 around an outer surface of the central conductor 11. Then, mix and extrude the first conductive material 131 and the second conductive material 132 to form the shielding layer 13 around an outer surface of the insulating layer 12, so that the extruded shielding layer 13 surrounds the insulating layer 12. Finally, form the outer jacket 14 to surround the shielding layer 13 and complete the coaxial cable structure 1 of the present invention. The coaxial cable structure 1 can be manufactured with reduced material in upgraded efficiency. The coaxial cable structure 1 can be used with connectors (not shown) to transmit signals between electronic apparatus, and the shielding layer 13 can effectively prevent interference by noise in the process of signal transmission via the coaxial cable structure 1. That is, the coaxial cable structure 1 of the present invention can have improved shielding effect.

The coaxial cable structure of the present invention is novel, improved and industrially practical for use. The present invention is novel and improved because the extruded shielding layer surrounding the insulating layer can replace the conventional woven shielding layer to provide improved shielding effect while allowing the coaxial cable to be manufactured with reduced material in upgraded efficiency. The present invention is industrially practical for use because products derived from the present invention would no doubt fully satisfy the current market demands.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A coaxial cable structure, comprising:
a central conductor;
an insulating layer surrounding the central conductor;
a shielding layer surrounding the insulating layer and being formed by mixing and extruding at least a first conductive material and a second conductive material; and
an outer jacket surrounding the shielding layer.

2. The coaxial cable structure as claimed in claim 1, wherein the central conductor is made of a copper material.

3. The coaxial cable structure as claimed in claim 1, wherein the insulating layer is made of a material selected from the group consisting of plastics, rubber, polytetrafluoroethylene (PTFE), polyvinylchloride (PVC), and other equivalent materials with similar property.

4. The coaxial cable structure as claimed in claim 1, wherein the first conductive material is selected from the group consisting of conductive plastics and other materials with similar property.

5. The coaxial cable structure as claimed in claim 1, wherein the second conductive material is selected from the group consisting of metal powder and other materials with similar property.

6. The coaxial cable structure as claimed in claim 1, wherein the outer jacket is made of a material selected from the group consisting of plastics, rubber, polytetrafluoroethylene (PTFE), polyvinylchloride (PVC), and other equivalent materials with similar property.
